(19) United States
(12) Patent Application Publication
(10) Pub. No.: US 2012/0049769 A1
(43) Pub. Date: Mar. 1, 2012

(54) LIGHTING DEVICE DRIVING APPARATUS, LIGHTING DEVICE DRIVING SYSTEM, AND DRIVING METHOD THEREOF

(75) Inventors: Chih-Yuan Su, Hsinchu City (TW); Hsu-Min Chen, Hsinchu City (TW)

(73) Assignee: ITE TECH. INC., Hsinchu (TW)

(21) Appl. No.: 12/909,847

(22) Filed: Oct. 22, 2010

(30) Foreign Application Priority Data
Aug. 27, 2010 (TW) 99128836

(51) Int. Cl. H05B 37/00

(52) U.S. Cl. 315/363

(57) ABSTRACT

A lighting device driving apparatus, a lighting device driving system, and a driving method thereof are provided. The lighting device driving system includes a signal generation unit and N lighting device driving apparatuses. The signal generation unit generates a serial data flow, wherein the serial data flow includes at least N data frames. The 1^{st} lighting device driving apparatus is coupled to the signal generation unit, and the i^{th} lighting device driving apparatus is coupled to the (i+1)^{th} lighting device driving apparatus. A signal processing unit of the lighting device driving apparatus detects identification codes of the data frames to receive control data of the i^{th} data frame and adjusts the identification code of the i^{th} data frame into a non-standard data format. Thereby, the lighting device driving system can receive the control data without any address and reduce interference to the serial data flow.

### CROSS-REFERENCE TO RELATED APPLICATION

This application claims the priority benefit of Taiwan application serial no. 99128836, filed on Aug. 27, 2010. The entirety of the above-mentioned patent application is hereby incorporated by reference herein and made a part of this specification.

### BACKGROUND OF THE INVENTION

1. Field of the Invention

The present invention generally relates to a lighting device driving technique, and more particularly, to a lighting device driving technique wherein control data is transmitted by detecting and modifying identification codes of data frames in a serial data flow.

2. Description of Related Art

The digital multiplex with 512 individual information (DMX-512) protocol is the most commonly adopted standard for controlling stage lighting and related equipments, and which is developed by the United State Institute for Theatre Technology, Inc (USITT) in August, 1986. The DMX-512 protocol is simple, robust, and flexible therefore is broadly adopted for controlling lighting dimmable devices, color lighting devices, fog machines, and other equipments that can be controlled with digital signals in the entertainment lighting field.

A conventional lighting device driving system adopting the DMX-512 protocol has a parallel control framework. FIG. 1 is a block diagram of a conventional lighting device driving system 10. Referring to FIG. 1, the signal generator 110 continuously transmits serial data flows through a signal line SL in an asynchronous serial format. Each of the serial data flows contains a plurality of data frames, and the data frames respectively carry the control data of the corresponding lighting device driving apparatuses 120_1-120_N, wherein N is a positive integer. All the lighting device driving apparatuses 120_1-120_3 are connected to the signal line SL in parallel. Thus, the lighting device driving apparatuses 120_{—1}-120_3 have to be disposed with the address storage units 130_1-130_3 and capture the corresponding data frames from the serial data flow by using addresses stored in the address storage units 130_1-130_3 in order to obtain the correct control data. For example, if the address stored in the address storage unit 130_1 of the lighting device driving apparatus 120_1 is “1”, the lighting device driving apparatus 120_1 captures the first data frame in the serial data flow, if the address stored in the address storage unit 130_2 of the lighting device driving apparatus 120_2 is “2”, the lighting device driving apparatus 120_2 captures the second data frame in the serial data flow, and so on. The signal generator 110 also needs to determine the sequence of the control data according to the addresses stored in the address storage units 130_1-130_3 of the lighting device driving apparatuses 120_1-120_3.

Since the address storage units 130_1-130_3 have to be disposed in the lighting device driving apparatuses 120_1-120_3 for storing predetermined addresses, the cost of the lighting device driving system 10 is increased. Besides, because the signal line SL has to be laid out from the signal generator 110 to the lighting device driving apparatuses 120_1-120_3, the length and the deployment cost of the signal line SL are increased.

### SUMMARY OF THE INVENTION

Accordingly, the present invention is directed to a lighting device driving apparatus, wherein the states of data frames in a serial data flow are detected and the data frames in a standard data format are received and adjusted into a non-standard data format, so that the access of address storage units and interference to the serial data flow are both reduced.

The present invention is also directed to a lighting device driving system, wherein each lighting device driving apparatus obtains the corresponding control data according to the sequence in which the lighting device driving apparatuses are connected in series and constantly transmits and adjusts data frames in a serial data flow in order to reduce interference to the serial data flow.

The present invention is further directed to a lighting device driving method, wherein lighting device driving apparatuses are controlled to obtain the corresponding control data according to the sequence in which the lighting device driving apparatuses are connected in series, so that corresponding data frames can be received without any address, and interference to the serial data flow can be reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional lighting device driving system.

FIG. 2 is a block diagram of a lighting device driving system according to a first embodiment of the present invention.

FIG. 3 is a diagram of serial data flows in a lighting device driving system according to the first embodiment of the present invention.

FIG. 4 illustrates the format of a data frame according to the first embodiment of the present invention.

FIG. 5 is a block diagram of a lighting device driving apparatus according to the first embodiment of the present invention.

FIG. 6 is a block diagram illustrating a first example of a signal processing unit according to the first embodiment of the present invention.

FIG. 7 is a diagram of the signal processing unit in FIG. 6.

FIG. 8 is a block diagram illustrating a second example of a signal processing unit according to the first embodiment of the present invention.

FIG. 9 is a diagram of the signal processing unit in FIG. 8.

FIG. 10 is a block diagram of a lighting device driving apparatus according to a second embodiment of the present invention.

FIG. 11 is a block diagram of a lighting device driving system according to the second embodiment of the present invention.

FIG. 12 is a flowchart of a lighting device driving method according to the first embodiment of the present invention.

FIG. 13 is a block diagram of another lighting device driving apparatus according to the first embodiment of the present invention.

FIG. 14 is a flowchart of a lighting device driving method adaptable to the lighting device driving apparatus in FIG. 13.

FIG. 15 is a block diagram of yet another lighting device driving apparatus according to the first embodiment of the present invention.

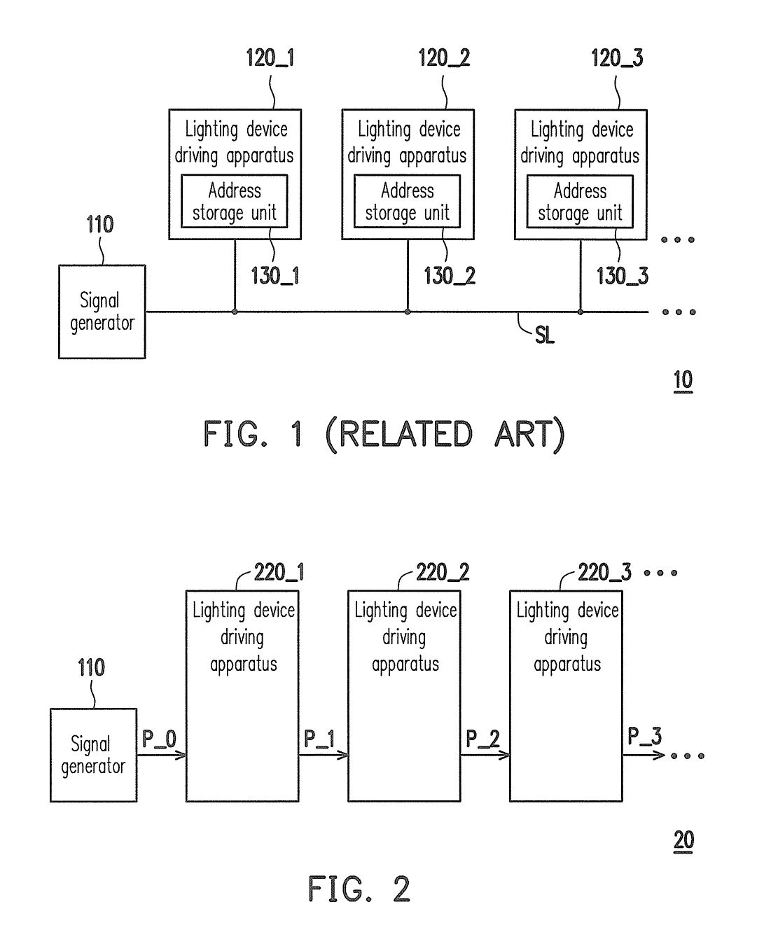

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a block diagram of a lighting device driving system 20 according to a first embodiment of the present invention. Referring to FIG. 2, the lighting device driving system 20 includes a signal generation unit 210 and N lighting device driving apparatuses 220_1-220_N, wherein N is a positive integer. In the present embodiment, the three lighting device driving apparatuses 220_1-220_3 are described as examples. The signal generation unit 210 generates a serial data flow P_0 according to the connection sequence of the lighting device driving apparatuses 220_1-220_N and the control data corresponding to the lighting device driving apparatuses 220_1-220_N. The first lighting device driving apparatus 220_1 is coupled to the signal generation unit 210 and the second lighting device driving apparatus 220_2, the second lighting device driving apparatus 220_2 is coupled to the third lighting device driving apparatus 220_3, . . . , and the i^{th} lighting device driving apparatus 220_{—}i is coupled to the (i+1)^{th} lighting device driving apparatus 220_(i+1), so that a series connection framework of the lighting device driving system 20 is constituted, wherein i is a positive integer and 1<=i<=N.

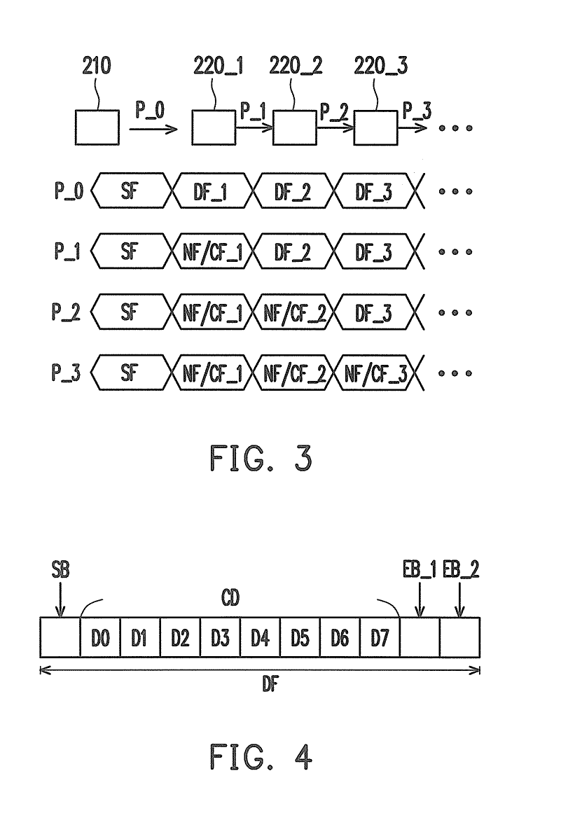

Herein the formats of the serial data flow P_0 and the data frames will be explained. FIG. 3 is a diagram illustrating the serial data flows P_0-P_3 of the lighting device driving system 20 according to the first embodiment of the present invention, and FIG. 4 illustrates the format of a data frame DF according to the first embodiment of the present invention. Referring to FIG. 3, in the present embodiment, the serial data flow P_0 generated by the signal generation unit 210 conforms to the standard digital multiplex with 512 individual information (DMX-512) protocol. Thus, the serial data flow P_0 includes an activation code SF and at least N data frames DF_1-DF_N, wherein the activation code SF is the initial synchronous data of the serial data flow. The format of the data frames DF_1-DF_N is as shown in FIG. 4, wherein the data frame DF has a start bit SB, eight data bits D0-D7, and two end bits EB_1 and EB_2. In the present embodiment, the start bit SB and the end bits EB_1 and EB_2 are referred as identification codes of the data frame DF, and the format of the data frame DF is determined according to these identification codes. In the present embodiment, the data D0-D7 of the data frames DF_1-DF_N are all used for carrying the control data CD of the corresponding lighting device driving apparatuses 220_1-220_N.

Then, the lighting device driving apparatuses 220_1-220_N determine the data format of the data frame DF by detecting the identification code of the data frame DF. The connection between the identification codes (i.e., the start bit SB and the end bits EB_1 and EB_2) and the data format is listed in following table (1).

TABLE 1

| Start | Control | End Bit | End Bit | |
|---|---|---|---|---|
| Bit SB | Data CD | EB_1 | EB_2 | Data Format |
| 0 | 00 - FF | 1 | 1 | Standard Data |
| | | | | Format |
| 0 | 00 - FF | 1 | 0 | Null Format |
| 0 | 00 - FF | 0 | 1 | Null Format |
| 0 | 00 - FF | 0 | 0 | Null Format |
| 1 | 00 - FF | 1 | 1 | Null Format |
| 1 | 00 - FF | 1 | 0 | Null Format |
| 1 | 00 - FF | 0 | 1 | Null Format |
| 1 | 00 - FF | 0 | 0 | Null Format |

In foregoing table (1), “0” indicates that the current bit is at a logic low level, and “1” indicates that the current bit is at a logic high level. As shown in table (1), according to the standard DMX-512 protocol, when the start bit SB is at the logic low level and the end bits EB_1 and EB_2 are at the logic high level, the data format of the data frame DF is the standard data format. Namely, the data D0-D7 in the data frame DF is valid data. For the convenience of description, the identification codes of the standard data format are expressed as (SB, EB_1, EB_2)=(0, 1, 1). Contrarily, when the identification codes (SB, EB_1, EB_2)≠(0, 1, 1) (for example, the identification codes (SB, EB_1, EB_2) are (0, 1, 0) or (1, 1, 1)), the identification codes of the data frame DF are in a non-standard data format. In the present embodiment, the non-standard data format is referred to as a null format NF. Namely, the data D0-D7 in the data frame DF is invalid data.

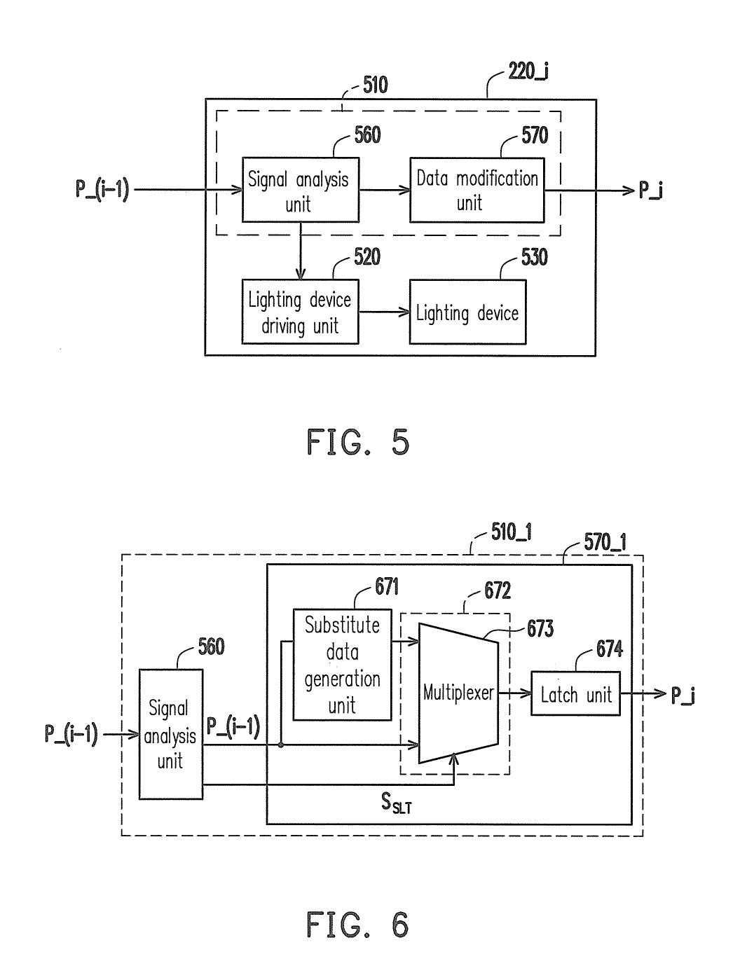

Below, in order to allow those having ordinary knowledge in the art to better understand the present invention, the activation procedures, functions, and structures of the lighting device driving apparatuses 220_1-220_N will be described in detail by taking the i^{th} lighting device driving apparatus 220_{—}i as an example. FIG. 5 is a block diagram of the i^{th} lighting device driving apparatus 220_{—}i according to the first embodiment of the present invention. Referring to FIG. 5, the lighting device driving apparatus 220_{—}i includes a signal processing unit 510, a lighting device driving unit 520, and a lighting device 530. In the present embodiment, the signal processing unit 510 includes a signal analysis unit 560 and a data modification unit 570. The signal analysis unit 560 receives a serial data flow P_(i−1), and after receiving the activation code SF, the signal analysis unit 560 sequentially detects whether the identification code of each data frame in the serial data flow P_(i−1) is in the standard data format. Herein the first data frame to the (i−1)^{th} data frame are all determined to be in the non-standard data format by the signal analysis unit 560, and the i^{th} data frame is determined to be in the standard data format by the signal analysis unit 560. The lighting device driving unit 520 is coupled to the signal processing unit 510, and which controls the lighting device 530 according to the control data CD received by the signal processing unit 510 from the i^{th} data frame DF_i. The data modification unit 570 adjusts the identification codes (SB, EB_1, EB_2) of the i^{th} data frame DF_i in the serial data flow P_i into the non-standard data format (i.e., the null format NF) and outputs the serial data flow P_i to the (i+1)^{th} lighting device driving apparatus.

For example, referring to both FIG. 3 and FIG. 5, when N is 1, the signal analysis unit 560 of the lighting device driving apparatus 220_1 receives a serial data flow P_0, and after receiving the activation code SF, the signal analysis unit 560 detects that the first data frame in the standard data format is the data frame DF_1. Accordingly, the lighting device driving unit 520 of the lighting device driving apparatus 220_1 receives the control data CD of the first data frame DF_1, and the data modification unit 570 adjusts the identification codes of the data frame DF_1 into the null format NF (expressed as NF/DF_1) and outputs the first data frame DF_1 to the lighting device driving apparatus 220_2. The data frames DF_2, DF_3 . . . connected in series after the data frame DF_1 are directly output to the lighting device driving apparatus 220_2. As to the lighting device driving apparatus 220_2, the serial data flow output by the lighting device driving apparatus 220_1 is marked as P_1.

When N is 2, the signal analysis unit 560 of the lighting device driving apparatus 220_2 receives the serial data flow P_1, and after receiving the activation code SF, the signal analysis unit 560 detects that the first data frame in the standard data format is the data frame DF_2. Accordingly, the lighting device driving unit 520 of the lighting device driving apparatus 220_2 receives the control data CD of the data frame DF_2, and the data modification unit 570 adjusts the identification codes of the data frame DF_2 into the null format NF (expressed as NF/DF_2) and outputs the data frame DF_2 to the lighting device driving apparatus 220_3. The NF/DF_1 connected prior to the data frame DF_2 and the data frames DF_2, DF_3 . . . connected after the data frame DF_1 are directly output to the lighting device driving apparatus 220_3. As to the lighting device driving apparatus 220_3, the serial data flow output by the lighting device driving apparatus 220_2 is marked as P_2.

Accordingly, the lighting device driving apparatuses 220_1-220_N in the lighting device driving system 20 can sequentially obtain the control data CD of the corresponding data frames DF_1-DF_N according to the sequence in which the lighting device driving apparatuses 220_1-220_N are connected in series.

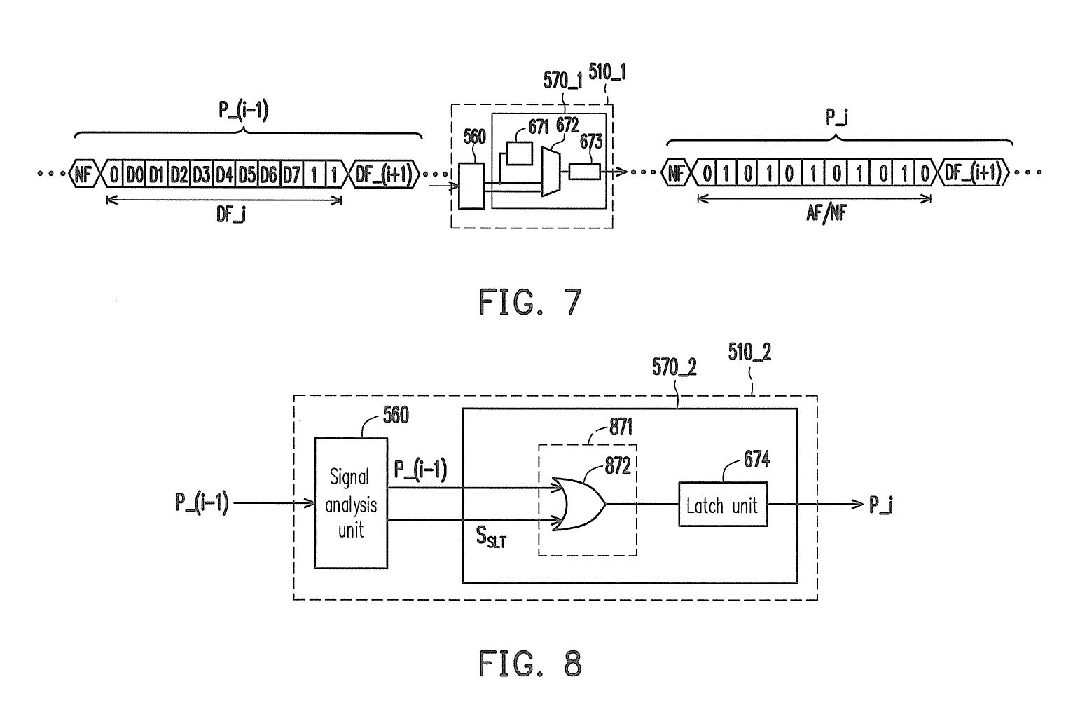

The signal processing unit 510 in the present embodiment as illustrated in FIG. 5 can be implemented in many different ways. Herein two implementations thereof will be described as examples. The first example is illustrated in FIG. 6 and FIG. 7. FIG. 6 is a block diagram illustrating the first example of the signal processing unit 510 according to the first embodiment of the present invention, and FIG. 7 is a diagram of the signal processing unit 510 in FIG. 6. Referring to FIG. 6, the data modification unit 570 of the signal processing unit 510 includes a substitute data generation unit 671 and a selective transmission unit 672. The substitute data generation unit 671 generates a substitute data frame AF (for example, the substitute data frame AF in FIG. 7) in advance by using an external signal or an internal data. The identification codes of the substitute data frame AF are in the null format NF. For example, the identification codes (SB, EB_1, EB_2) of the substitute data frame AF in FIG. 7 are (0, 1, 0) in the null format NF.

The selective transmission unit 672 includes a multiplexer 673. The selection terminal of the multiplexer 673 receives a selection signal S_{SLT}, the first input terminal thereof receives the serial data flow P_(i−1), and the second input terminal thereof is coupled to the substitute data generation unit 671 to receive the substitute data frame AF. Besides, in the present embodiment, when the signal analysis unit 560 detects that the identification codes of the data frame DF_i in the serial data flow P_(i−1) are in the standard data format, the selection signal S_{SLT} is enabled (for example, at the logic high level). However, the selection signal S_{SLT} is disabled (for example, at the logic low level) at the rest of the time.

As shown in FIG. 6 and FIG. 7, when the lighting device driving apparatus 220_{—}i is about to transmit the data frame DF_i to the (i+1)^{th} lighting device driving apparatus (i.e., the selection signal S_{SLT} is enabled), the selective transmission unit 672 transmits the substitute data frame AF as the data frame DF_i. Besides, when the lighting device driving apparatus 220_{—}i is about to transmit data frames other than the data frame DF_i to the (i+1)^{th} lighting device driving apparatus (i.e., the selection signal S_{SLT} is disabled), the selective transmission unit 672 directly transmits the serial data flow P_(i−1) to the (i+1)^{th} lighting device driving apparatus. Additionally, in the present embodiment, the signal processing unit 510 illustrated in FIG. 6 and FIG. 7 is further coupled to a latch unit 674 at the output terminal of the multiplexer 673, wherein the latch unit 674 is used for temporarily storing and transmitting the serial data flow P_i.

In other embodiments, those skilled in the art may also preset substitute identification codes in the null format in the substitute data generation unit 671 and transmit the substitute identification codes as the identification codes of the data frame DF_i in the serial data flow P_i through the selective transmission unit 672 without adjusting the data D0-D7 of the data frame DF_i. However, the present invention is not limited herein.

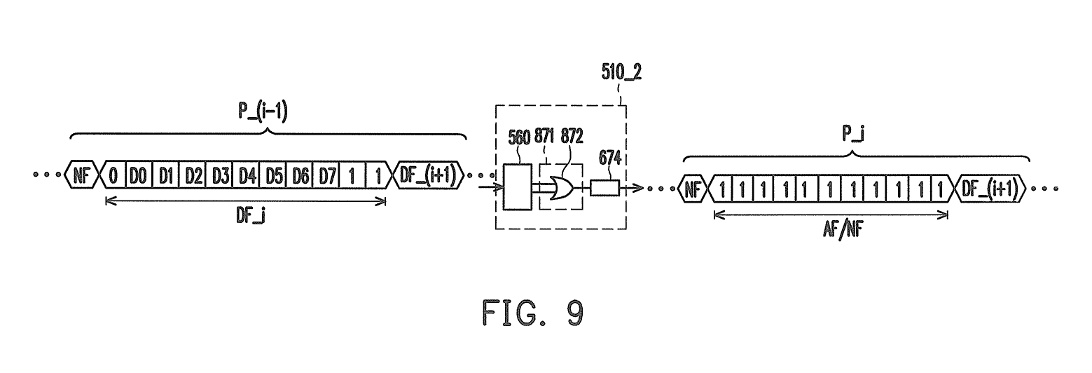

The second example is illustrated in FIG. 8 and FIG. 9. FIG. 8 is a block diagram illustrating a second example of the signal processing unit 510 according to the first embodiment of the present invention, and FIG. 9 is a diagram of the signal processing unit 510 in FIG. 8. The data modification unit 570 includes a logic operation unit 871 and a latch unit 674. Herein the logic operation unit 871 is described as an OR gate 872. The first input terminal of the OR gate 872 receives the selection signal S_{SLT}, the second input terminal of the OR gate 872 receives the serial data flow P_(i−1), and the output terminal of the OR gate 872 is coupled to the latch unit 674. Herein the latch unit 674 is used for temporarily storing and transmitting the serial data flow P_i, as that described in foregoing example.

As shown in FIG. 8 and FIG. 9, when the lighting device driving apparatus 220_{—}i is about to transmit the data frame DF_i to the (i+i)^{th} lighting device driving apparatus (i.e., the selection signal S_{SLT} is enabled (in the present embodiment, the selection signal S_{SLT} is at the logic high level when it is enabled)), a substitute data frame AF having each of its bits at the logic high level is generated through the logic operation of the OR gate 872 and used for substituting the data frame DF_i. Besides, when the lighting device driving apparatus 220_{—}i is about to transmit data frames other than the data frame DF_i to the (i+1)^{th} lighting device driving apparatus (i.e., the selection signal S_{SLT} is disabled (in the present embodiment, the selection signal S_{SLT} is at the logic low level when it is disabled)), the OR gate 872 transmits the serial data flow P_(i−1) to the (i+1)^{th} lighting device driving apparatus.

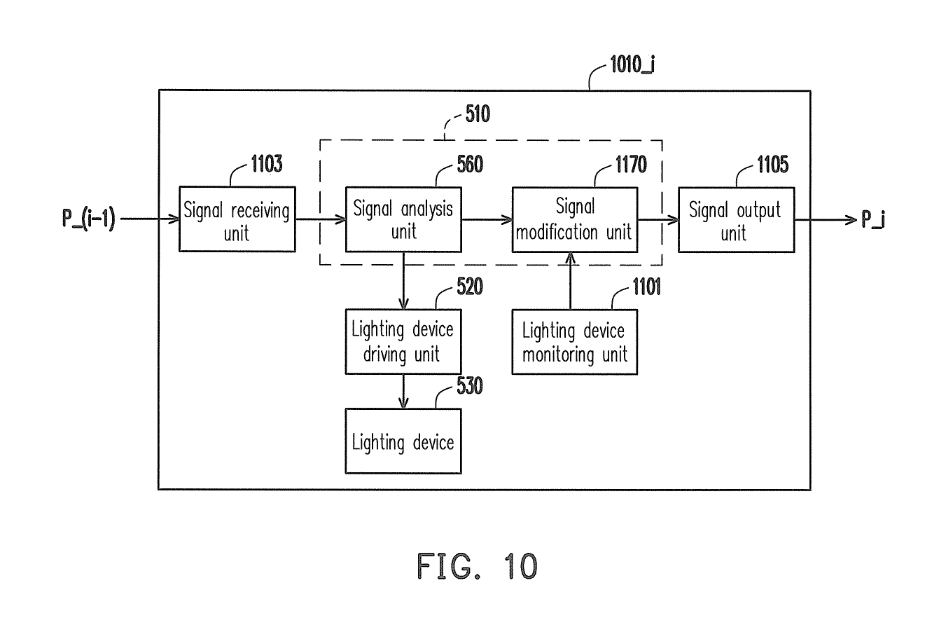

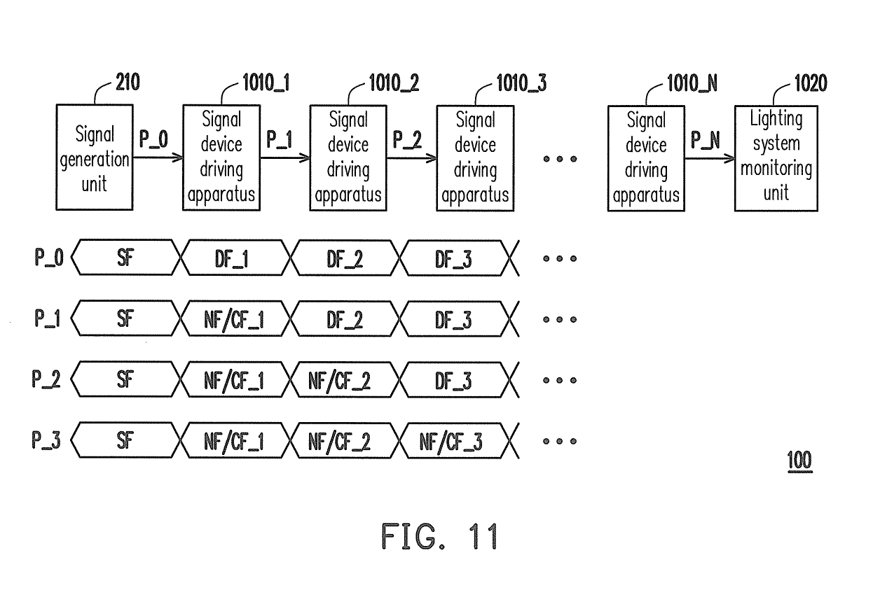

A second embodiment of the present invention is illustrated in FIG. 10 and FIG. 11. FIG. 10 is a block diagram of a lighting device driving apparatus 1010_{—}i according to the second embodiment of the present invention. Referring to FIG. 3, FIG. 5, and FIG. 10, the signal processing unit 510, the lighting device driving unit 520, the lighting device 530, and the signal analysis unit 560 of the lighting device driving apparatus 1010_{—}i illustrated in FIG. 10 are similar to those in the first embodiment therefore will not be described herein. In the second embodiment, a lighting device monitoring unit 1101 is further disposed in the lighting device driving apparatus 1010_{—}i for detecting the state of the lighting device 530, such as the temperature, short circuit/open circuit, and/or other situations related to the lighting device 530. Besides adjusting the identification codes of the data frame DF_i into the null format NF, the signal modification unit 1170 also encodes the state of the lighting device into the 8-bit data D0-D7 of the data frame DF_i to obtain a lighting device state data frame CF_i and transmits the lighting device state data frame CF_i as the data frame DF_i (marked as NF/CF_i in FIG. 11). Or, the signal modification unit 1170 encodes the state of the lighting device into an 11-bit lighting device state data frame CF_i and transmits the lighting device state data frame CF_i as the data frame DF_i, wherein the identification codes of the lighting device state data frame CF_i are also in the null format NF so that the next lighting device driving apparatus can receive the control data successfully.

FIG. 11 is a block diagram of a lighting device driving system 100 according to the second embodiment of the present invention. In the lighting device driving system 100, a lighting system monitoring unit 1020 is connected at the end (i.e., after the N^{th} lighting device driving apparatus 1010_N) in series. The lighting system monitoring unit 1020 receives a serial data flow P_N and monitors the states of the lighting devices in the lighting device driving apparatuses 1010_1-1010_N. In addition, the lighting device driving apparatus 1010_{—}i in FIG. 10 further includes a signal receiving unit 1103 and a signal output unit 1105. The signal receiving unit 1103 receives a serial data flow P_(i−1), converts it into a digital data, and transmits the converted data to the signal processing unit 510. The signal output unit 1105 transmits the serial data flow P_i through the signal line between the lighting device driving apparatus 1010_{—}i and the lighting device driving apparatus 1010_(i+1). Other aspects of the present embodiment have been described in detail in foregoing embodiments therefore will not be described herein.

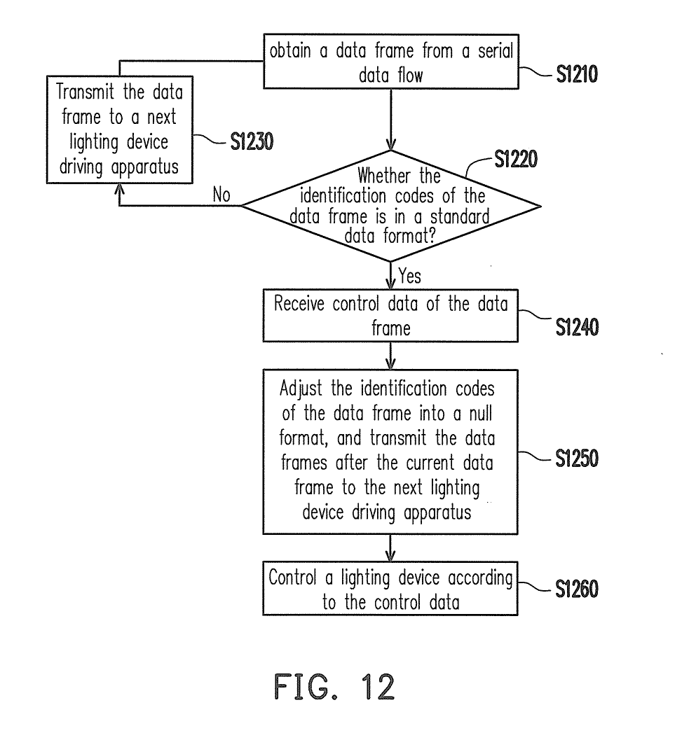

FIG. 12 is a flowchart of a lighting device driving method according to the first embodiment of the present invention. Referring to FIG. 12, the lighting device driving method in the present embodiment is adaptable to a lighting device driving apparatus, and which includes following steps. First, in step S1210, a first data frame is obtained from a serial data flow. Then, in step S1220, identification codes of the data frame are detected to determine the data format thereof. If the identification codes of the data frame are in a null format, in step S1230, the data frame is transmitted to a next lighting device driving apparatus, and the procedure returns to step S1210 to obtain a next data frame from the serial data flow.

Contrarily, if the identification codes of the data frame are in a standard data format, the procedure proceeds from step S1220 to step S1240 to receive the control data of the data frame. After that, in step S1250, the identification codes of the first data frame are adjusted into the null format, and the data frame and the subsequent data frames are transmitted to the next lighting device driving apparatus. Next, in step S1260, a lighting device is controlled according to the control data received in step S1240. Other aspects of the present embodiment have been described in detail in foregoing embodiments therefore will not be described herein.

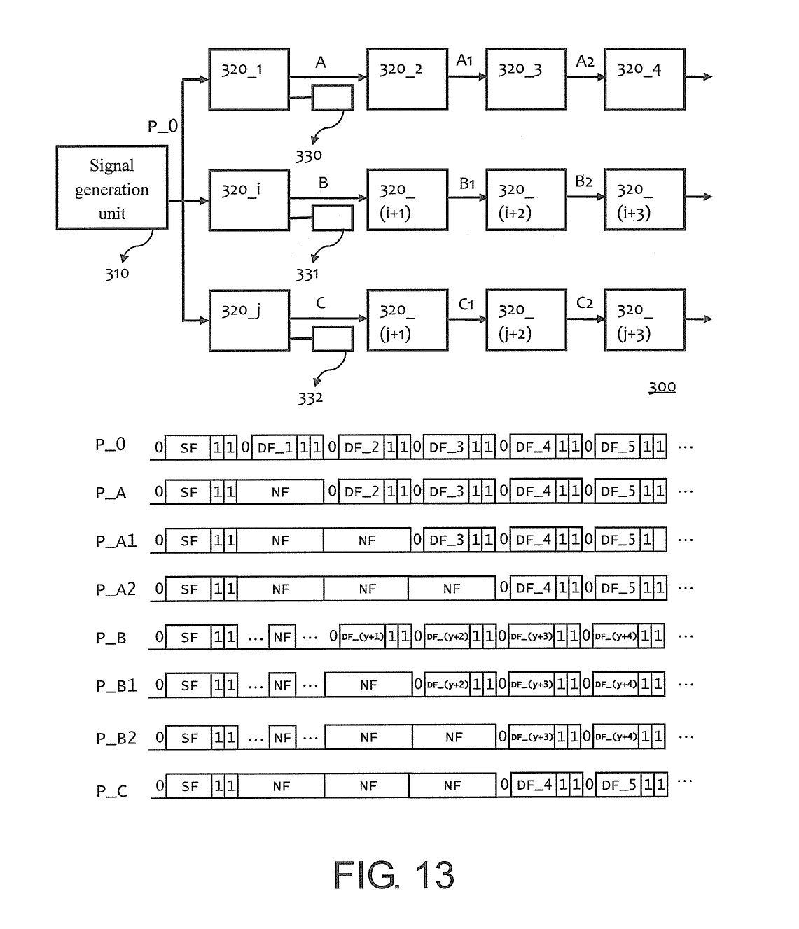

FIG. 13 is a block diagram of another lighting device driving apparatus 300 according to the first embodiment of the present invention. Referring to FIG. 13, a serial data flow P_0 generated by a signal generation unit 310 and serial data flows P_A, P_A1, P_A2, P_B, P_B1, P_B2, P_C, P_C1, and P_C2 observed at the nodes A, A1, A2, B, B1, B2, C, C1, and C2 are illustrated. As shown in FIG. 13, the lighting device driving system 300 includes the signal generation unit 310 and N lighting device driving apparatuses 320_1-320_N. In the present embodiment, the lighting device driving apparatuses 320_1-320_4, 320_{—}i-320_(i+3), and 320_{—}j-320_(j+3) are described as examples. The signal generation unit 310 generates the serial data flow P_0 according to the sequence in which the lighting device driving apparatuses 320_1-320_N are connected in series/parallel and the control data corresponding to the lighting device driving apparatuses 320_1-320_N. The first lighting device driving apparatus 320_1, the i^{th} lighting device driving apparatus 320_{—}i, and the j^{th} lighting device driving apparatus 320_{—}j are connected in parallel, and the lighting device driving apparatuses 320_1-320_(i+3) and 320_{—}j-320_(j+3) are connected in series. Herein i, j, and N are positive integers and 1<i<j<N.

As shown in FIG. 13, each of the lighting device driving apparatuses that are connected in parallel is coupled to an address storage unit. In the present embodiment, the lighting device driving apparatus 320_1 is coupled to an address storage unit 330. The address storage unit 330 stores the address of “x”, wherein x=1. The lighting device driving apparatus 320_{—}i is coupled to an address storage unit 331. The address storage unit 331 stores the address of “y”, wherein y>=1. The lighting device driving apparatus 320_{—}j is coupled to an address storage unit 332. The address storage unit 332 stores the address of “z”, wherein z=4. Taking the operation of the lighting device driving apparatus 320_{—}i as an example, the lighting device driving apparatus 320_{—}i reads the address storage unit 331 to obtain an address y. The lighting device driving apparatus 320_{—}i receives a serial data flow P_0 from the signal generation unit 310, wherein the serial data flow P_0 includes an activation code and a plurality of data frames, and each of the data frames includes at least one identification code and a control data. The lighting device driving apparatus 320_{—}i first obtains the activation code SF from the serial data flow and outputs the activation code SF to a next lighting device driving apparatus 320 (i+1). The lighting device driving apparatus 320_{—}i considers the y^{th} data frame DF_y after the activation code SF as its own data frame and receives the control data of the data frame DF_y, and the lighting device driving apparatus 320_{—}i then adjusts the identification codes of the first to the y^{th} data frame into the null format NF (i.e., the non-standard data format) and outputs the first to the y^{th} data frames to the next lighting device driving apparatus 320 (i+1).

Taking the lighting device driving apparatus 320_{—}j as another example, the lighting device driving apparatus 320_{—}j reads address data 4 from the address storage unit 332. The lighting device driving apparatus 320_{—}j receives the serial data flow P_0 from the signal generation unit 310. The lighting device driving apparatus 320_{—}j obtains the activation code SF from the serial data flow P_0 and outputs the activation code SF to the next lighting device driving apparatus 320_(j+1). The lighting device driving apparatus 320_{—}j considers the fourth data frame DF_4 after the activation code SF as its own data frame and receives the control data of the data frame DF_4, and the lighting device driving apparatus 320_{—}j adjusts the identification codes of the first to the fourth data frames into the null format NF (i.e., the non-standard data format) and outputs the first to the fourth data frames to the next lighting device driving apparatus 320_(j+1). Thereby, in the present embodiment, the lighting device driving apparatus 320_{—}j and the lighting device driving apparatus 320_4 receive the control data of the same data frame DF_4.

The operation of the serially connected lighting device driving apparatuses 320_(i+1)-320_(i+3) and 320_(j+1)-320_(j+3) can be referred to the descriptions related to FIG. 3 or FIG. 12 and will not be described herein.

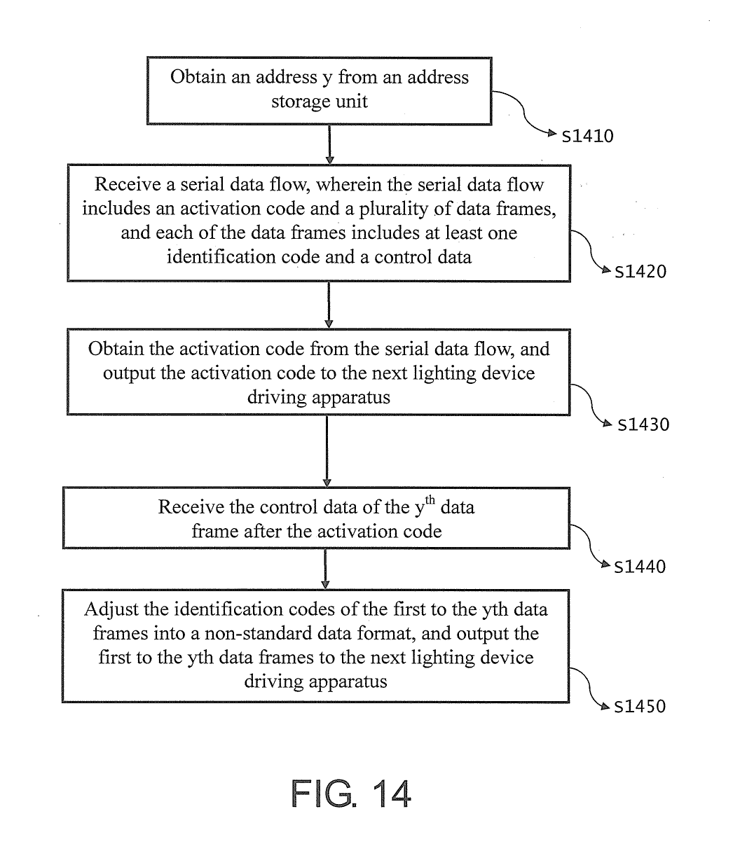

FIG. 14 is a flowchart of a lighting device driving method adaptable to the lighting device driving apparatus in FIG. 13. Referring to FIG. 14, the lighting device driving method in the present embodiment is adaptable to a lighting device driving apparatus, and which includes following steps. First, in step S1410, an address y is obtained from an address storage unit. Then, in step S1420, a serial data flow is received, wherein the serial data flow includes an activation code and a plurality of data frames, and each of the data frames includes at least one identification code and a control data. Next, in step S1430, an activation code is obtained from the serial data flow, and the activation code is output to a next lighting device driving apparatus. After that, in step S1440, the control data of the y^{th} data frame after the activation code SF is received. Then, in step S1450, the identification codes of the data frames DF_1-DF_y are adjusted into the non-standard data format, and the data frames DF_1-DF_y are output to a next lighting device driving apparatus.

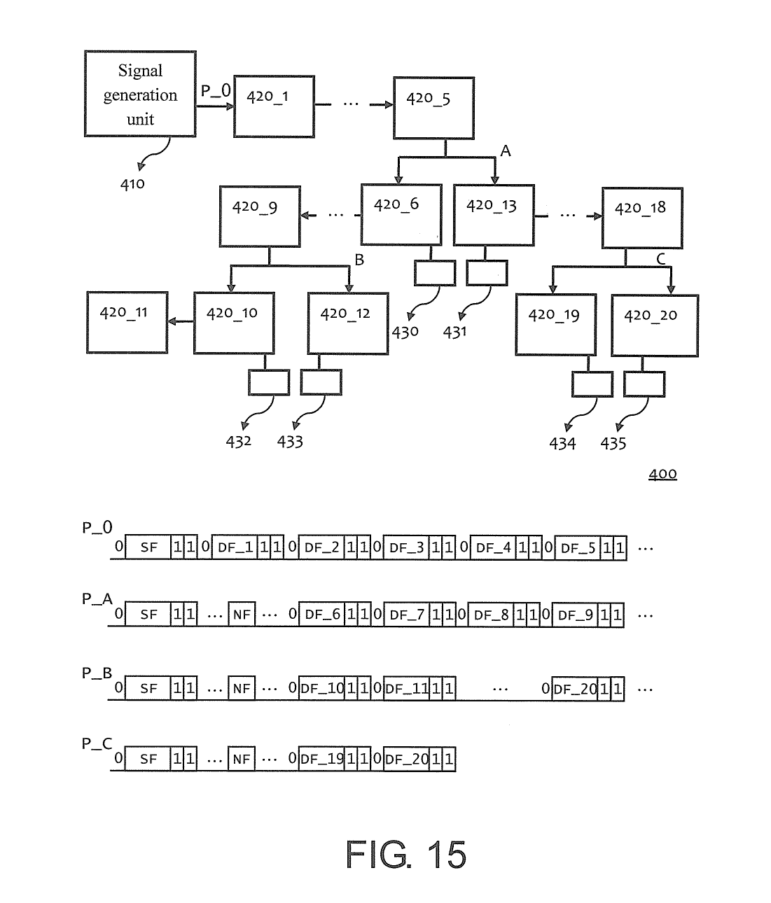

FIG. 15 is a block diagram of yet another lighting device driving apparatus 400 according to the first embodiment of the present invention. Referring to FIG. 15, a serial data flow P_0 generated by a signal generation unit 410 and serial data flows P_A, P_B, and P_C observed at the nodes A, B, and C are illustrated. As shown in FIG. 15, the lighting device driving system 400 includes the signal generation unit 410 and N lighting device driving apparatuses 420_1-420_N, wherein N is a positive integer. In the present embodiment, 20 lighting device driving apparatuses 420_1-420_20 are taken as examples. The signal generation unit 410 generates the serial data flow P_0 according to the sequence in which the lighting device driving apparatuses 420_1-420_20 are connected in series/parallel and the control data corresponding to the lighting device driving apparatuses 420_1-420_20. The first lighting device driving apparatus 420_1 to the fifth lighting device driving apparatus 420_5 (five in total), the sixth lighting device driving apparatus 420_6 to the ninth lighting device driving apparatus 420_9 (4 in total), the tenth lighting device driving apparatus 420_10 and the eleventh lighting device driving apparatus 420_11 (2 in total), and the thirteenth lighting device driving apparatus 420_13 to the eighteenth lighting device driving apparatus 420_18 (6 in total) are connected in series. The sixth lighting device driving apparatus 420_6 and the thirteenth lighting device driving apparatus 420_13, the tenth lighting device driving apparatus 420_10 and the twelfth lighting device driving apparatus 420_12, and the nineteenth lighting device driving apparatus 420_19 and the twentieth lighting device driving apparatus 420_20 are connected in parallel.

As shown in FIG. 15, each of the lighting device driving apparatuses that are connected in parallel is coupled to an address storage unit. In the present embodiment, the lighting device driving apparatus 420_6 is coupled to an address storage unit 430, wherein the address storage unit 430 stores the address of “u”. The lighting device driving apparatus 420_13 is coupled to an address storage unit 431, wherein the address storage unit 431 stores the address of “v”. The lighting device driving apparatus 420_10 is coupled to an address storage unit 432, wherein the address storage unit 432 stores the address of “w”. The lighting device driving apparatus 420_12 is coupled to an address storage unit 433, wherein the address storage unit 433 stores the address of “x”. The lighting device driving apparatus 420_19 is coupled to an address storage unit 434, wherein the address storage unit 434 stores the address of “y”. The lighting device driving apparatus 42020 is coupled to an address storage unit 435, wherein the address storage unit 435 stores the address of “z”.

The operation of the serially connected lighting device driving apparatuses 420_1-420_5 can be referred to the description related to FIG. 3 or FIG. 12. After the lighting device driving apparatus 420_5 adjusts the identification codes of the data frame DF_5 into the null format NF, the data frames DF_1-DF_5 observed at the node A are all in the null format NF, and the first valid data frame is the data frame DF_6. Thus, the data frames after the data frame DF_6 are all valid data frames. Taking the lighting device driving apparatuses 420_6 and 420_13 as examples, the lighting device driving apparatus 420_6 reads the address u from the address storage unit 430, wherein u>=1. The lighting device driving apparatus 420_6 receives a serial data flow P_A and then considers the u^{th} data frame DF_u after the activation code SF as its own data frame. The lighting device driving apparatus 420_6 receives the control data of the data frame DF_u, adjusts the identification codes of the first to the u^{th} data frames into the null format NF, and outputs the first to the u^{th} data frames to the next lighting device driving apparatus 420_7. Similarly, the lighting device driving apparatus 420_13 reads the address v from the address storage unit 431, wherein v>=1. The lighting device driving apparatus 420_13 receives the serial data flow P_A and then considers the v^{th} data frame DF_v after the activation code SF as its own data frame. The lighting device driving apparatus 420_13 receives the control data of the data frame DF_v, adjusts the identification codes of the first to the v^{th} data frames into the null format NF, and outputs the first to the v^{th} data frames to the next lighting device driving apparatus 420_14. The operations of the subsequent lighting device driving apparatuses 420_7-420_9 and 420_14-420_18 can be referred to the description related to FIG. 3 or FIG. 12 therefore will not be described herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lighting device driving apparatus, receiving a serial data flow, wherein the serial data flow comprises a plurality of data frames, and each of the data frames comprises at least one identification code and a control data, the lighting device driving apparatus comprising:
a signal processing unit, for receiving the serial data flow and sequentially detecting the identification code of each of the data frames to determine a data format, wherein when a first data frame determined to be in a standard data format is the i^{th} data frame, the signal processing unit receives the control data of the i^{th} data frame, adjusts the identification code of the i^{th} data frame into a non-standard data format, and transmits the serial data flow to another lighting device driving apparatus, wherein i>=1 and the i^{th} data frame is one of the data frames; and
a lighting device driving unit, coupled to a lighting device, for controlling the lighting device according to the control data.

2. The lighting device driving apparatus according to claim 1, wherein the signal processing unit comprises:
a signal analysis unit, for receiving the serial data flow and sequentially detecting whether the identification code of each of the data frames is in the standard data format, so as to receive the control data of the first data frame; and
a data modification unit, coupled to the signal analysis unit, for adjusting the identification code of the first data frame into the non-standard data format when the serial data flow is transmitted to another lighting device driving apparatus.

3. The lighting device driving apparatus according to claim 2, wherein the data modification unit comprises:
a substitute data generation unit, for generating or predetermining a substitute data frame, wherein the identification code of the substitute data frame is in the non-standard data format; and
a selective transmission unit, for transmitting the substitute data frame as the first data frame when the first data frame is transmitted to another lighting device driving apparatus.

4. The lighting device driving apparatus according to claim 2, wherein the data modification unit comprises a logic operation unit, and the logic operation unit transmits a substitute data frame as the first data frame when the first data frame is transmitted to another lighting device driving apparatus, wherein the identification code of the substitute data frame is in the non-standard data format.

5. The lighting device driving apparatus according to claim 2 further comprising a lighting device monitoring unit, wherein the lighting device monitoring unit detects a state of the lighting device, the lighting device driving apparatus generates a lighting device state data frame according to the state of the lighting device and transmits the lighting device state data frame as the first data frame when the first data frame is transmitted to another lighting device driving apparatus, wherein the identification code of the lighting device state data frame is in the non-standard data format.

6. The lighting device driving apparatus according to claim 1, wherein the identification codes comprise a start bit and an end bit sequence, the end bit sequence comprises a first end bit and a second end bit, and the control data is an 8-bit data.

7. The lighting device driving apparatus according to claim 6, wherein when the start bit is at a logic low level and the first end bit and the second end bit are at a logic high level, the identification codes are in the standard data format.

8. A lighting device driving system, comprising:
a signal generation unit, for generating a serial data flow, wherein the serial data flow comprises at least N data frames, and each of the data frames comprises at least one identification code and a control data, wherein N is a positive integer; and
N lighting device driving apparatuses, wherein the first lighting device driving apparatus is coupled to the signal generation unit, and the i^{th} lighting device driving apparatus is coupled to the (i+1)^{th} lighting device driving apparatus, wherein i is a positive integer and 1<=i<=N, and the i^{th} lighting device driving apparatus comprises:
a signal processing unit, for receiving the serial data flow and sequentially determining whether the identification code of each of the data frames is in a standard data format, so as to receive the control data of the i^{th} data frame, adjust the identification code of the i^{th} data frame into a non-standard data format, and transmit the serial data flow to the (i+1)^{th} lighting device driving apparatus; and
a lighting device driving unit, coupled to a lighting device, for controlling the lighting device according to the control data.

9. The lighting device driving system according to claim 8, wherein the signal processing unit comprises:
a signal analysis unit, for receiving the serial data flow and sequentially determining whether the identification code of each of the data frames is in the standard data format, so as to receive the control data of the i^{th} data frame; and
a data modification unit, coupled to the signal analysis unit, for adjusting the identification code of the i^{th} data frame into the non-standard data format when the serial data flow is transmitted to the (i+1)^{th} lighting device driving apparatus.

10. The lighting device driving system according to claim 9, wherein the data modification unit comprises:
a substitute data generation unit, for generating a substitute data frame, wherein the identification code of the substitute data frame is in the non-standard data format; and
a selective transmission unit, for transmitting the substitute data frame as the i^{th} data frame when the i^{th} data frame is transmitted to the (i+1)^{th} lighting device driving apparatus.

11. The lighting device driving system according to claim 9, wherein the i^{th} lighting device driving apparatus further comprises a lighting device monitoring unit for detecting a state of the lighting device, the lighting device driving apparatus generates an i^{th} lighting device state data frame according to the state of the lighting device and transmits the i^{th} lighting device state data frame as the i^{th} data frame when the i^{th} data frame is transmitted to the (i+1)^{th} lighting device driving apparatus, wherein the identification code of the i^{th} lighting device state data frame is in the non-standard data format.

12. The lighting device driving system according to claim 11 further comprising a lighting system monitoring unit coupled to the N^{th} lighting device driving apparatus, wherein the lighting system monitoring unit receives the serial data flow and monitors the states of the lighting devices according to the lighting device state data frames.

13. The lighting device driving system according to claim 8, wherein the identification codes comprise a start bit and an end bit sequence, the end bit sequence comprises a first end bit and a second end bit, and the control data is an 8-bit data.

14. The lighting device driving system according to claim 13, wherein when the start bit is at a logic low level and the first end bit and the second end bit are at a logic high level, the identification codes are in the standard data format.

15. A lighting device driving method, adaptable to a lighting device driving apparatus, the lighting device driving method comprising:
receiving a serial data flow, wherein the serial data flow comprises a plurality of data frames, and each of the data frames comprises at least one identification code and a control data;
sequentially detecting the identification code of each of the data frames to determine a data format;
when a first data frame determined to be in a standard data format is the i^{th} data frame, receiving the control data of the i^{th} data frame, wherein i>=1 and the i^{th} data frame is one of the data frames;
adjusting the identification code of the i^{th} data frame into a non-standard data format, and transmitting the serial data flow to another lighting device driving apparatus; and
controlling a lighting device according to the control data.

16. The lighting device driving method according to claim 15, wherein the step of adjusting the identification code of the first data frame into the non-standard data format comprises:
generating a substitute data frame, wherein the identification code of the substitute data frame is in the non-standard data format; and
transmitting the substitute data frame as the first data frame when the first data frame is transmitted to another lighting device driving apparatus.

17. The lighting device driving method according to claim 15 further comprising:
detecting a state of the lighting device, and generating a lighting device state data frame according to the state of the lighting device, wherein the identification code of the lighting device state data frame is in the non-standard data format; and
transmitting the lighting device state data frame as the first data frame when the first data frame is transmitted to another lighting device driving apparatus.

18. The lighting device driving method according to claim 15, wherein the identification codes comprise a start bit and an end bit sequence, the end bit sequence comprises a first end bit and a second end bit, and the control data is an 8-bit data.

19. The lighting device driving method according to claim 18, wherein when the start bit is at a logic low level and the first end bit and the second end bit are at a logic high level, the identification codes are in the standard data format.

20. A lighting device driving system, comprising:
a signal generation unit, for generating a serial data flow, wherein the serial data flow comprises M data frames, and each of the data frames comprises at least one identification code and a control data, wherein M is a positive integer; and
N lighting device driving apparatuses, wherein N is a positive integer, the first lighting device driving apparatus and the i^{th} lighting device driving apparatus are connected in parallel and are coupled to the signal generation unit, the first lighting device driving apparatus to the (i−1)^{th} lighting device driving apparatus are connected in series, and the lighting device driving apparatus to the N^{th} lighting device driving apparatus are also connected in series, wherein i is a positive integer and 1<i<=N, and the i^{th} lighting device driving apparatus comprises:
an address storage unit, for storing an address y, wherein y is a positive integer and y>=1;
a signal processing unit, coupled to the address storage unit, for reading the address y from the address storage unit, wherein the signal processing unit receives the serial data flow, obtains a control data from the y^{th} data frame, adjusts the identification codes of the first to the y^{th} data frames into a non-standard data format, and transmits the serial data flow to the (i+1)^{th} lighting device driving apparatus; and
a lighting device driving unit, coupled to a lighting device, for controlling the lighting device according to the control data.

21. The lighting device driving system according to claim 20, wherein the identification codes comprise a start bit and an end bit sequence, the end bit sequence comprises a first end bit and a second end bit, and the control data is an 8-bit data.

22. The lighting device driving system according to claim 21, wherein when the start bit is at a logic low level, the first end bit is at a logic high level, and the second end bit is at the logic low level, when the start bit is at the logic low level, the first end bit is at the logic low level, and the second end bit is at the logic high level, when the start bit is at the logic low level, the first end bit is at the logic low level, and the second end bit is at the logic low level, when the start bit is at the logic high level, the first end bit is at the logic high level, and the second end bit is at the logic high level, when the start bit is at the logic high level, the first end bit is at the logic high level, and the second end bit is at the logic low level, when the start bit is at the logic high level, the first end bit is at the logic low level, and the second end bit is at the logic high level, or when the start bit is at the logic high level, the first end bit is at the logic low level, and the second end bit is at the logic low level, the identification codes are in the non-standard data format.

23. A lighting device driving method, adaptable to a lighting device driving apparatus, the lighting device driving method comprising:
obtaining an address y from an address storage unit;
receiving a serial data flow, wherein the serial data flow comprises an activation code and a plurality of data frames, and each of the data frames comprises at least one identification code and a control data;
obtaining the activation code from the serial data flow, and outputting the activation code to a next lighting device driving apparatus;
receiving the control data of the y^{th} data frame after the activation code; and
adjusting the identification codes of the first data frame to the y^{th} data frame into a non-standard data format, and outputting the first data frame to the y^{th} data frame to the next lighting device driving apparatus.

24. The lighting device driving method according to claim 23, wherein the identification codes comprise a start bit and an end bit sequence, the end bit sequence comprises a first end bit and a second end bit, and the control data is an 8-bit data.

25. The lighting device driving method according to claim 24, wherein when the start bit is at a logic low level, the first end bit is at a logic high level, and the second end bit is at the logic low level, when the start bit is at the logic low level, the first end bit is at the logic low level, and the second end bit is at the logic high level, when the start bit is at the logic low level, the first end bit is at the logic low level, and the second end bit is at the logic low level, when the start bit is at the logic high level, the first end bit is at the logic high level, and the second end bit is at the logic high level, when the start bit is at the logic high level, the first end bit is at the logic high level, and the second end bit is at the logic low level, when the start bit is at the logic high level, the first end bit is at the logic low level, and the second end bit is at the logic high level, or when the start bit is at the logic high level, the first end bit is at the logic low level, and the second end bit is at the logic low level, the identification codes are in the non-standard data format.

26. A lighting device driving system, comprising:
a signal generation unit, for generating a serial data flow, wherein the serial data flow comprises M data frames, and each of the data frames comprises at least one identification code and a control data, wherein M is a positive integer; and
N lighting device driving apparatuses, wherein N is a positive integer, the i^{th} lighting device driving apparatus and the j^{th} lighting device driving apparatus are coupled to the (i−1)^{th} lighting device driving apparatus, the i^{th} lighting device driving apparatus and the j^{th} lighting device driving apparatus are connected in parallel, and the first lighting device driving apparatus to the (i−1)^{th} lighting device driving apparatus are connected in series, wherein i is a positive integer and 1<i<j<=N, and the (i−1)^{th} lighting device driving apparatus outputs a (i−1)^{th} serial data flow,
wherein the i^{th} lighting device driving apparatus comprises:
an address storage unit, for storing an address u, wherein u is a positive integer and u>=1; and
a signal processing unit, coupled to the address storage unit, for reading the address u from the address storage unit, receiving the (i−1)^{th} serial data flow, obtaining the control data from the u^{th} data frame, adjusting the identification codes of the first data frame to the u^{th} data frame into a non-standard data format, and transmitting the (i−1)^{th} serial data flow to the (i+1)^{th} lighting device driving apparatus,
and wherein the j^{th} lighting device driving apparatus comprises:
an address storage unit, for storing an address v, wherein v is a positive integer and v>=1; and
a signal processing unit, coupled to the address storage unit, for reading the address v from the address storage unit, receiving the (i−1)^{th} serial data flow, obtaining the control data from the j^{th} data frame, adjusting the identification codes of the first data frame to the v^{th} data frame into the non-standard data format, and transmitting the (i−1)^{th} serial data flow to the (j+1)^{th} lighting device driving apparatus.

27. The lighting device driving system according to claim 26, wherein the identification codes comprise a start bit and an end bit sequence, the end bit sequence comprises a first end bit and a second end bit, and the control data is an 8-bit data.

28. The lighting device driving system according to claim 27, wherein when the start bit is at a logic low level, the first end bit is at a logic high level, and the second end bit is at the logic low level, when the start bit is at the logic low level, the first end bit is at the logic low level, and the second end bit is at the logic high level, when the start bit is at the logic low level, the first end bit is at the logic low level, and the second end bit is at the logic low level, when the start bit is at the logic high level, the first end bit is at the logic high level, and the second end bit is at the logic high level, when the start bit is at the logic high level, the first end bit is at the logic high level, and the second end bit is at the logic low level, when the start bit is at the logic high level, the first end bit is at the logic low level, and the second end bit is at the logic high level, or when the start bit is at the logic high level, the first end bit is at the logic low level, and the second end bit is at the logic low level, the identification codes are in the non-standard data format.
